(19) United States
(12) Patent Application Publication
(10) Pub. No.: US 2006/0268855 A1
(43) Pub. Date: Nov. 30, 2006

(54) Communication apparatus for real-time embedded control

(75) Inventors: Wayne D. Brandt, Morton, IL (US); Travis O. Breitkreutz, Peoria, IL (US); Mike R. Lyons, Peoria, IL (US)

Correspondence Address: CATERPILLAR/FINNEGAN, HENDERSON, L.L.P., 901 New York Avenue, NW, WASHINGTON, DC, 20001-4413, US

(73) Assignee: Caterpillar Inc.

(21) Appl. No.: 11/139,652

(22) Filed: May 31, 2005

(51) Int. Cl. H04L 12/56

(52) U.S. Cl. 370/389

(57) ABSTRACT

A communication apparatus is provided, which may include a node having a processor and a computer-readable medium, the node being associated with an electrical component of a real-time embedded control system configured to control one or more electronic components. The communication apparatus may further include a program stored on the computer readable medium that, when executed by the processor, is operable to identify data to be communicated, and divide the data into one or more frames. Each frame may include a frame header and a frame data payload portion. The frame data payload portion may include one or more segments, forming a sequence of segments, each segment including a segment header including segment data indicating a location of the segment in the sequence. The segment may also include a segment data payload portion.

### TECHNICAL FIELD

The present disclosure is directed to a communication apparatus for real-time embedded control and, more particularly, to a communication apparatus configured to divide data into frames, which are further divided into segments.

### BACKGROUND

Many devices include real-time embedded control systems. Real-time embedded control systems may be associated with work machines, such as construction equipment, which may include electrical components that are communicably coupled to each other through one or more communication conduits. Examples of such electrical components may include electronic control units (ECUs), network managers, control panels, etc.

The communication of data between electrical components of real-time embedded control systems may follow a suitable communications protocol. Data may be divided and sent as one or more frames (i.e., packets of data), and each frame may include a header and one or more data segments. Each data segment may have its own header and a data payload portion. The data to be sent is allocated to the payload sections of the data segments. Many real-time embedded control systems may use Controller Area Network (CAN), a standardized serial data communications bus developed by Bosch. Data payload portions of CAN data segments may be eight bytes in size.

Depending on the communications protocol used, the header of the frame may include the source and destination addresses of the frame. For certain protocols such as the internet protocol, the source and destination addresses are global, meaning that the source and destination addresses are unique in the worldwide web. Such global addresses may be relatively large in size, and thus, can be cumbersome to process. Further, in some instances, the header of each data segment may include local source and destination addresses.

The data segments may be reassembled at the destination in the correct order to reformulate the frame. To enable a correct reassembly, each data segment includes segment data indicating the particular position of the data segment relative to other data segments. Historically, segment data has occupied the data payload portion of the data segments, thus, reducing the data carrying capacity of the data segments. For example, data segments organized according to CAN have historically used one of the eight bytes of the data payload portion of the data segment for segment data, leaving seven bytes for the transport of data.

For real-time systems, the data payload portions of data segments may be relatively small (e.g., 8 bytes as in CAN) as compared to, for example, the internet protocol, so as to avoid tying up the data link for extended periods, which is more likely to occur if larger data segments are transmitted. Because of the smaller size of data payload portions in real-time systems, the data carrying capacity of each segment is more significantly impacted by using portions of the data payload portion for segment data. For example, using one of the 8 bytes in a CAN data segment payload portion for segment data reduces the data carrying capacity of the data segment by over 12%.

Systems have been developed that incorporate segment data into the segment header. For example, U.S. Pat. No. 6,859,442, issued on Feb. 22, 2005 to Agarwal et al. (“the '442 patent”), discloses a system for transporting data in packets, which are further segmented into smaller units called spackets. The '442 patent discloses that the headers of the spackets may include sequence numbers dictating the order in which the spackets are to be reassembled.

While the system of the '442 patent includes spacket sequence data in the spacket headers, the system of the '442 patent does not specify that the data payload portion is necessarily devoid of any spacket sequence data. Further, the system of the '442 patent is not configured to generate communications for real-time embedded control systems. In addition, there is no disclosure of providing the system of the '442 patent in a local environment, such as a work machine, wherein real-time communication may be especially critical to controlling components, such as an engine.

The disclosed communication apparatus is directed toward overcoming one or more of the shortcomings set forth above.

### SUMMARY OF THE INVENTION

In one aspect, the present disclosure is directed to a communication apparatus. The communication apparatus may include a node having a processor and a computer-readable medium, the node being associated with an electrical component of a real-time embedded control system configured to control one or more electronic components. The communication apparatus may further include a program stored on the computer readable medium that, when executed by the processor, is operable to identify data to be communicated, and divide the data into one or more frames. Each frame may include a frame header and a frame data payload portion. The frame data payload portion may include one or more segments, forming a sequence of segments, each segment including a segment header including segment data indicating a location of the segment in the sequence. The segment may include a segment data payload portion.

In another aspect, the present disclosure is directed to a method of communicating between electrical components of a real-time embedded control system. The method may include identifying data to be communicated and dividing the data into one or more frames, each frame including a frame header and a frame data payload portion. The frame data payload portion may include one or more segments, forming a sequence of segments. Each segment may include a segment header, including segment data indicating a location of the segment in the sequence, and a segment data payload portion.

In another aspect, the present disclosure is directed to a work machine having a frame, a power source, and a real-time embedded control system configured to control one or more functions of the work machine. The real-time embedded control system may include a node having a processor and a computer-readable medium, the node being associated with an electrical component of the real-time embedded control system. The system may also include a program stored on the computer readable medium. When executed by the processor, the program may be operable to identify data to be communicated and divide the data into one or more frames. Each frame may include a frame header including destination address information corresponding to a location within a local network and a frame data payload portion including one or more segments forming a sequence of segments. Each segment may include a segment data payload portion and a segment header. The segment header may include the destination address information, segment data indicating a location of the segment in the sequence, and priority data indicating a transmission priority level of the segment.

### BRIEF DESCRIPTION OF THE DRAWINGS

FIG. 1 is a diagrammatic illustration of a maintenance module interfaced with a work machine according to an exemplary disclosed embodiment.

FIG. 2 is a diagrammatic illustration of a data frame according to an exemplary disclosed embodiment.

### DETAILED DESCRIPTION

Reference will now be made in detail to the drawings. Wherever possible, the same reference numbers will be used throughout the drawings to refer to the same or like parts.

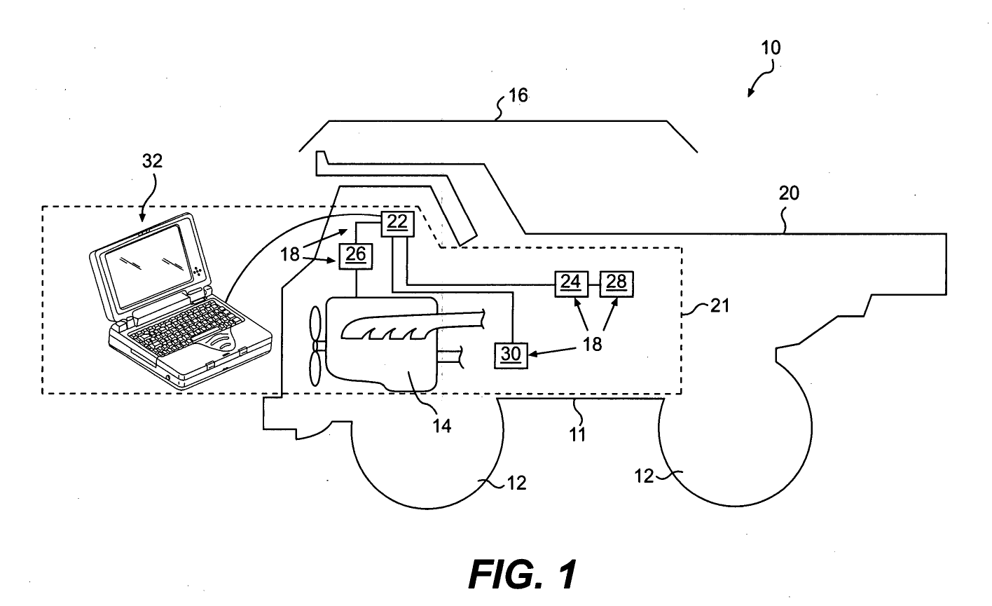

FIG. 1 illustrates a work machine 10. Work machine 10 may include a frame 11, one or more traction devices 12, a power source 14, and a real-time embedded control system 16, including one or more electrical components 18. Although work machine 10 is shown as a truck, work machine 10 could be any type of machine having a real-time embedded control system. Accordingly, traction devices 12 may be any type of traction devices, such as, for example, wheels, as shown in FIG. 1, tracks, belts, or any combinations thereof.

Power source 14 may be any type of power source. For example, power source 14 may include an electric motor, fuel cell, engine, or any other type of power source. Power source 14, may include any type of engine, including internal combustion engines, e.g., gasoline engines, diesel engines, natural gas engines, or any other type of engine. One or more operating parameters of power source 14 may be controllable with real-time embedded control system 16.

For purposes of this disclosure, the term “embedded control system” shall be defined as an electronic system wherein an electronic controller controls one or more electronic components. An example of “real-time” embedded control may include controlling one or more ongoing processes of a data collecting system by delivering commands and/or generating outputs in a substantially immediate fashion. For example, a real-time application may deliver commands and/or generate outputs in less than about one second and, more typically, in much shorter times, such as five to twenty milliseconds or less. The speed of delivery of commands and/or generation of outputs may be dependent on several factors including, for example, the operating speed of the system being controlled. For example, an engine control module (ECM) may deliver commands and monitor engine operating parameters at a faster rate (e.g., on the order of milliseconds) as operating parameters of an engine must be controlled fast enough to keep up with an engine operating at several hundred to several thousand RPM. Conversely, a simple data collection system, such as a dump cycle counter, may operate in real-time, but at slightly slower rates of data transmission (e.g., on the order of seconds).

Work machine 10 may also include a work tool 20. Such a work tool may include any type of device controllable by real-time embedded control system 16 to perform a function. As shown in FIG. 1, work tool 20 includes a dump body of a hauling vehicle. However, work tool 20 could include any device configured to perform any function of which work machine 10 is capable. For example, work tool 20 could include any type of work implement, such as buckets (e.g., excavator shovels, loader buckets, etc.), blades (e.g., dozer blades, motor grader blades, etc.), grapples, jackhammers, or any other actuatable device.

Real-time embedded control system 16 may be any electronic system configured to control one or more functions of work machine 10. Work machine 10 may be configured to monitor output, directly or indirectly, of components performing these functions. Real-time embedded control system 16 may be configured to control these functions based on the output monitored by work machine 10. Real-time embedded control system 16 may be configured to communicate between electrical components 18 within a local network (21), wherein one or more of electrical components 18 may be associated with a node of the local network. Electrical components 18 may include, for example, one or more processors, such as an electronic control unit (ECU) 22, an ECU 24, and/or an engine control module (ECM) 26. Electrical components 18, particularly ECU 22, ECU 24, and/or ECM 26, may include memory. Exemplary types of memory may include EPROM or EEPROM, such as flash memory, or any other kind of memory.

ECM 26 may be configured to control one or more operating parameters of power source 14. For example, ECM 26 may be configured to control electronic fuel injectors, electronic throttle controls, etc. ECM 26 may be configured to control these and/or other parameters based on data collected by ECM 26, such as emissions measurements, oxygen content in the exhaust, and closed loop feedback, such as fuel injector operation, air intake, and throttle position.

Electrical components 18 may also include one or more output devices controllable by ECUs. For example, ECU 24 may be configured to control operation of other work machine components such as work tool 20. In one embodiment, ECU 24 may be configured to control an output device, such as a solenoid valve 28 operable to control actuation of a hydraulic actuator (not shown) associated with work tool 20. Another example of an output device may include an electronic transmission control 30, which may be controlled by, for example, ECU 22.

An example of a function controlled by real-time embedded control system 16 could include a speed limiting feature. When the dump body (e.g., work tool 20) is in a raised position, ECU 22 may be configured to control gear selection of electronic transmission control 30. Other possibilities for real-time embedded control system 16 may include positioning and/or guidance systems. For example, work machine 10 may be configured to automatically guide itself along a predetermined path of travel based on positioning data determined by, for example, a global positioning system (GPS). In some embodiments, work machine 10 may be configured to control position of work tool 20 (e.g., dozer blades) based on global positioning information, such as GPS data and/or local positioning data, such as from laser-based positioning systems.

A maintenance module 32 may be configured to interface with the local network of real-time embedded control system 16, and may thereby be associated with a node of the network (e.g., maintenance module 32 may serve as a node of the network). Maintenance module 32 may include a service tool configured to transfer data to and/or receive data from electrical components 18 of real-time embedded control system 16. For example, maintenance module 32 may include any type of device for transferring data, such as, a laptop computer, a PDA, or other specialized equipment configured to interface with one or more of electrical components 18. Maintenance module 32 may be configured to update software of real-time embedded control system 16 by, for example, “flashing” or “flash reprogramming” one or more memories associated with electrical components 18.

Real-time embedded control system 16 may include a computer-readable medium coupled to at least one node of the local network. The computer-readable medium may include any hardware configured to store computer-readable software, such as any appropriate type of mass storage provided to store any type of information needed for real-time embedded control system 16 to function. For example, the computer-readable medium may include one or more hard disk devices, optical disk devices, or other storage devices to provide storage space. A program may be stored on the computer readable medium that, when executed by the processor, is operable to identify data to be communicated and divide the data into one or more frames. For example, the frames may be organized according to a standardized serial data communications bus, such as CAN.

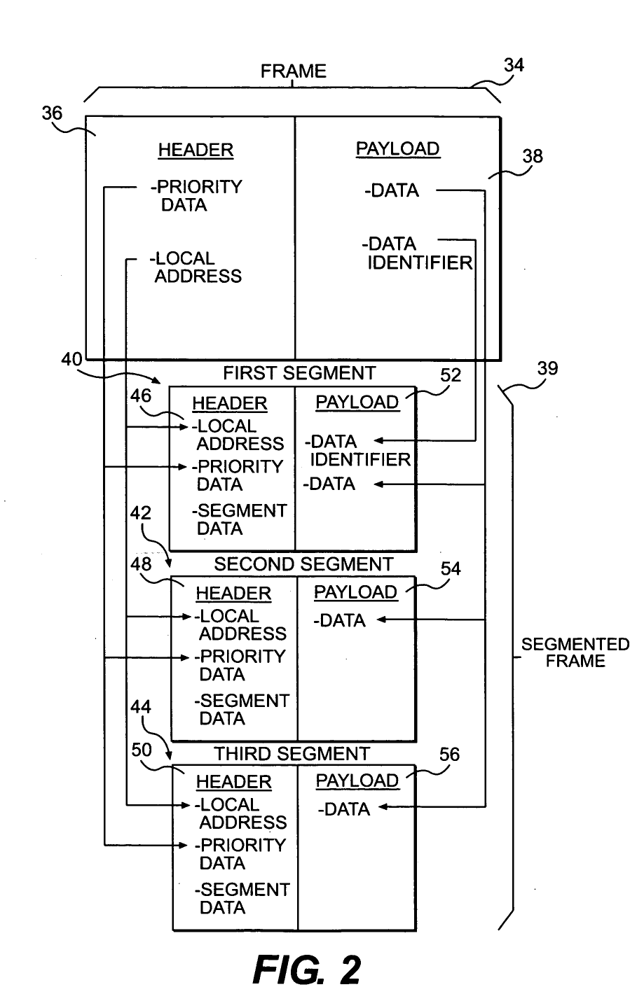

FIG. 2 illustrates an exemplary frame 34 into which data may be divided by the program. Each frame 34 may include a frame header 36 and a frame data payload portion 38. Frame header 36 may include local address information for the source and/or destination of the data. Frame data payload portion 38 may be further subdivided into one or more segments, thus forming a segmented frame 39.

FIG. 2, illustrates an exemplary sequence of segments, including a first segment 40, a second segment 42, and a third segment 44. First segment 40, second segment 42, and third segment 44 may include a first segment header 46, a second segment header 48, and a third segment header 50, respectively. First segment 40, second segment 42, and third segment 44 may also include a first segment data payload portion 52, a second segment data payload portion 54, and a third segment data payload portion 56, respectively.

Data from frame 34 may be replicated in one or more data segments as indicated by arrows in FIG. 2. Each of first segment header 46, second segment header 48, and third segment header 50 may include priority data specifying the transmission priority of the segment (i.e., the priority with which the respective segment should be transferred by nodes of the network). The priority data may be provided in a two-bit field, in order to free additional space in the segment headers. Each of first segment header 46, second segment header 48, and third segment header 50 may also include segment data indicating the location of the segment in the sequence (i.e., where, in the sequence, the segment belongs). The segment data may include a tag value, which may identify the frame with which each segment is associated. The segment headers may further include local addresses for the destination and/or source of the data.

### INDUSTRIAL APPLICABILITY

The present disclosure may be applicable to a wide variety of devices. The present disclosure may be applicable to any kind of machine, which incorporates a real-time embedded control system. For example, such machines may include regular household appliances, such as clothes dryers and microwaves, which can have real-time embedded control systems that operate the equipment based on sensor feedback. Clothes dryers may have sensor dry programs that stop the dryer when a moisture sensor detects that the clothes are dry. Microwaves can have programs that cook food until a moisture sensor detects that the food is finished cooking.

The present disclosure may also be applicable to more industrial types of equipment, such as HVAC systems (e.g., electronic and, in some cases, programmable thermostats) or power generation sets (e.g., gas turbine engines that drive electric generators). Further, the present disclosure may be applicable to mobile work machines, such as on-road vehicles, as well as off-road vehicles, including both on-road and off-road construction and/or agricultural equipment. Such mobile work machines may include passenger cars, on and off-road hauling vehicles (e.g., dump trucks), earth moving equipment (e.g., track type tractors (a.k.a. bulldozers), loaders, excavators, or any other type of work machine having a real-time embedded control system.

The disclosed communication may facilitate installation of new and/or updated software to one or more of electrical components 18 of real-time embedded control system 16, which may be part of a local network. Alternatively or additionally, the disclosed communication apparatus may facilitate communication between electrical components 18.

Exemplary methods of using the disclosed communication apparatus may include communicating to or between electrical components 18, which may include identifying data to be communicated and dividing the data into one or more frames, each frame being further subdivided as discussed above. The methods may also include allocating the different types of data (e.g., priority data, segment data, address information, etc.) to particular subdivisions (e.g., segment headers, segment data payload portions) as discussed above.

Because the segment data may be included in the segment headers, the segment data payload portions need not include the segment data, thus more data carrying capacity may be available in the segment data payload portions. For example, in certain embodiments, a full eight bytes may be available to transport data in the data payload portion, rather than seven bytes where segment data takes up one of the payload bytes. In order to make room for the segment data in the segment headers, data identifier information may be removed from the segment headers. Data identifier information may be moved to the segment data payload portions. However, the data identifier information need only be included in first segment 40, leaving, for example, seven out of eight bytes of data payload capacity in first segment data payload portion 52. Subsequent segments (e.g., second segment 42 and third segment 44) may have the full eight bytes of space available to carry data as previously discussed.

Communicating to one or more of electrical components 18 may include updating software associated with at least one of electrical components 18 by transferring data from maintenance module 32. The step of updating software may include transferring data from maintenance module 32 to a work machine including electrical components 18. Communicating between electrical components 18 may include transmission of a variety of types of data. For example, such communication may include transmission of control signals for controlling operation of electrical components 18. Alternatively or additionally, such communication may include transmission of data collected by, for example, sensors associated with electrical components 18.

It will be apparent to those having ordinary skill in the art that various modifications and variations can be made to the disclosed communication apparatus for real-time embedded control without departing from the scope of the invention. Other embodiments of the invention will be apparent to those having ordinary skill in the art from consideration of the specification and practice of the invention disclosed herein. It is intended that the specification and examples be considered as exemplary only, with a true scope of the invention being indicated by the following claims and their equivalents.

What is claimed is:

1. A communication apparatus, comprising:
a node having a processor and a computer-readable medium, the node being associated with an electrical component of a real-time embedded control system configured to control one or more electronic components; and
a program stored on the computer readable medium that, when executed by the processor, is operable to:
identify data to be communicated; and
divide the data into one or more frames, each frame including:
a frame header; and
a frame data payload portion;
the frame data payload portion including one or more segments, forming a sequence of segments, each segment including:
a segment header including segment data indicating a location of the segment in the sequence; and
a segment data payload portion.

2. The apparatus of claim 1, wherein the segment header further includes priority data indicated in a two-bit field.

3. The apparatus of claim 1, wherein the frame header includes destination address information corresponding to one or more locations within a local network.

4. The apparatus of claim 1, wherein each segment header includes destination address information corresponding to one or more locations within a local network.

5. The apparatus of claim 1, wherein the segment data is not included in the segment data payload portion.

6. The apparatus of claim 1, wherein the segment data payload portion is an 8-byte field for transporting data.

7. The apparatus of claim 1, wherein the segment header does not include data identifier information.

8. The apparatus of claim 1, wherein the real-time embedded control system is associated with a work machine; and
wherein the node includes a maintenance module configured to transfer data to or receive data from the one or more electrical components of the embedded control system.

9. The apparatus of claim 8, wherein the one or more electrical components includes at least one of an electronic control unit (ECU) and an engine control module (ECM).

10. A method of communicating between electrical components of a real-time embedded control system, comprising:
identifying data to be communicated; and
dividing the data into one or more frames, each frame including a frame header and a frame data payload portion;
the frame data payload portion including one or more segments, forming a sequence of segments, each segment including:
a segment header including segment data indicating a location of the segment in the sequence; and
a segment data payload portion.

11. The method of claim 10, further including updating software associated with at least one of the components by transferring data to the at least one component from a maintenance module configured to interface with the at least one component.

12. The method of claim 11, wherein the step of updating software includes transferring data from the maintenance module, configured to interface with the components, to a work machine including the components.

13. The method of claim 10, further including providing priority data in a two-bit field of the segment header, the priority data indicating a transmission priority level of the segment.

14. The method of claim 10, further including incorporating into the frame header destination address information corresponding to one or more locations within a local network.

15. The method of claim 10, further including incorporating into each segment header destination address information corresponding to one or more locations within a local network.

16. The method of claim 10, wherein dividing the data does not include incorporating segment data into the segment data payload portion.

17. The method of claim 10, wherein dividing the data does not include incorporating data identifier information into the segment header.

18. The method of claim 10, further including transferring data to one or more electrical components associated with a work machine.

19. The method of claim 18, wherein the one or more electrical components includes at least one of an electronic control unit (ECU) and an engine control module (ECM).

20. A work machine, comprising:
a frame;
a power source;
a real-time embedded control system configured to control one or more functions of the work machine, the real-time embedded control system including:
a node having a processor and a computer-readable medium, the node being associated with an electrical component of the real-time embedded control system; and
a program stored on the computer readable medium that, when executed by the processor, is operable to:
identify data to be communicated; and
divide the data into one or more frames, each frame including:
a frame header including destination address information corresponding to a location within a local network; and
a frame data payload portion including one or more segments forming a sequence of segments;
each segment including:
a segment data payload portion; and
a segment header including the destination address information, segment data indicating a location of the segment in the sequence, and priority data indicating a transmission priority level of the segment.
